(19) United States
(12) Patent Application Publication
(10) Pub. No.: US 2025/0314519 A1
(43) Pub. Date: Oct. 9, 2025

(54) Vision Float

(71) Applicant: Cole Allan Peacock, Tavernier, FL (US)

(72) Inventor: Cole Allan Peacock, Tavernier, FL (US)

(21) Appl. No.: 18/895,156

(22) Filed: Sep. 24, 2024

Related U.S. Application Data
(60) Provisional application No. 63/573,940, filed on Apr. 3, 2024.

(51) Int. Cl. G01F 23/292; G01F 23/18

(52) U.S. Cl. CPC G01F 23/2925; G01F 23/18

(57) ABSTRACT

A method and system for monitoring and managing fluid levels. The method involves registering the fluid level monitoring system over cellular networks to connect with one or more servers. A user interface is provided through a dedicated application or web browser, enabling users to set alert thresholds and access live feeds and data analytics. The system activates one or more cameras and flashlights when the fluid level reaches a predetermined threshold, capturing a photograph of the interior conditions and transmitting it to the user with an alert notification. Additionally, the system detects any alteration in orientation using accelerometers when the monitoring system becomes submerged, thereby triggering an alert to the user. This method and system enhance fluid management by providing real-time monitoring and responsive alerts, ensuring users can swiftly address fluid level changes.

### FIELD OF THE INVENTION

The present invention relates generally to the fields of plumbing, electrical, and wastewater management. More specifically, the invention pertains to electrical devices or systems and industrial equipment designed for monitoring and managing fluid levels in various environments.

### BACKGROUND OF THE INVENTION

Electrical devices and industrial equipment designed for monitoring and managing fluid levels in various environments are in demand.

The management and monitoring of fluid levels within various containers, tanks, and structures are critical in numerous industries, notably within the wastewater sector. Traditional methods of monitoring such levels have often required manual inspection, which is not only time-consuming and labor-intensive but also poses significant safety risks to personnel. Furthermore, the lack of real-time data and alerts can lead to inefficient operations and, in some cases, environmental and structural damage due to overflows or leaks. Therefore, there exists a need for an advanced, intelligent solution that can offer precise, real-time monitoring and alerts to mitigate these challenges effectively.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A digital submersible fluid level monitoring device equipped with a downward-facing 4K wide-angle camera and an ultra-high intensity LED flash. It incorporates a distance measuring sensor, LTE cellular modem, Wi-Fi, and Bluetooth connectivity. Powered by an internal lithium-ion battery, it also features temperature and accelerometer sensors, along with a built-in AC to DC charging circuit.

### BRIEF DESCRIPTION OF THE DRAWINGS

FIG. 1 illustrates one embodiment of the fluid level monitoring system of the present invention.

FIG. 2 illustrates one embodiment of the fluid level monitoring system installed in a tank.

FIG. 3 illustrates one embodiment of the fluid level monitoring system showing the fluid reaching a predetermined threshold and altering the orientation of the system.

FIG. 4 is a block diagram illustrating one embodiment of the method of the present invention.

FIG. 5 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present invention, Vision Float, provides an innovative digital smart level monitoring system specifically engineered to transform the conventional methodologies employed in the monitoring of fluid levels within tanks, lift stations, and similar structures, with a particular emphasis on applications within the wastewater industry. The present invention is designed to facilitate real-time monitoring and issuance of high-level alerts, thereby significantly enhancing the operational efficiency and safety protocols by providing accurate visual and data insights into the conditions within any tank or structure it is deployed.

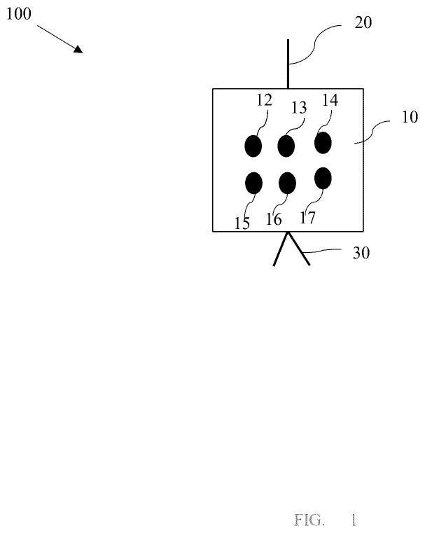

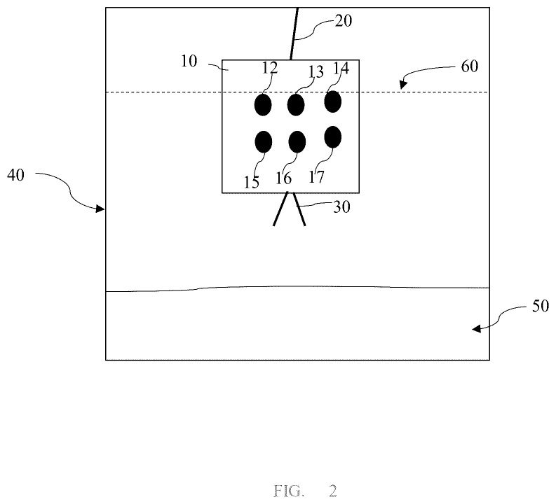

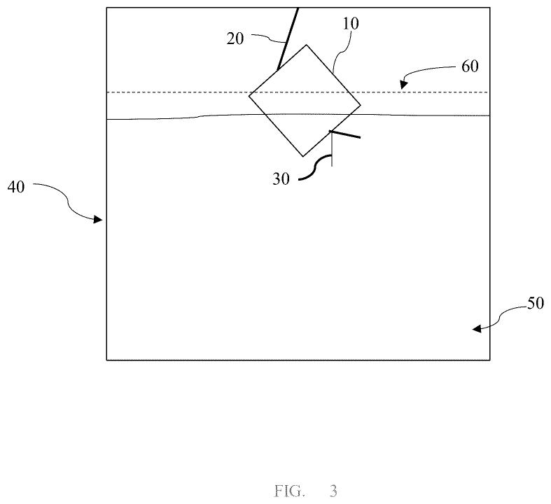

The present invention, Vision Float, is characterized by an assembly of high-performance components and features, meticulously integrated to ensure a comprehensive monitoring capability. As shown in FIGS. 1-3, the present invention includes: Imaging and Illumination Component, Sensing Technology, Connectivity Module, Power Supply Mechanism, Auxiliary Sensors, and Durability and Design connected together to form the Vision Float.

In one embodiment, the present invention provides a system (fluid level monitoring system) 100 that comprises a plurality of sensors 12 and accelerometers 13, cameras 14, flashlights 15, communication module (Connectivity Module) 16, a power supply 17, and a housing (with Durability and Design) 10.

In certain embodiments, the housing 10, which can take any suitable shape, may include multiple sensors 12, accelerometers 13, cameras 14, flashlights 15, a communication module 16, and a power supply 17. The housing 10 can be made from any material capable of floating on water, such as expanded polystyrene foam (Styrofoam), which is lightweight and buoyant. The multiple sensors 12, accelerometers 13, cameras 14, flashlights 15, and communication module 16 can be connected to the power supply 17.

The following are details of the components in certain embodiments:

Durability and Design: The system 100 can be encased in a watertight, impact-resistant clear ABS plastic shell, ensuring its buoyancy and durability. The compact design, reminiscent of a 12 oz soda can, facilitates ease of installation and integration into various operational environments.

Imaging and Illumination Component: The system 100 may incorporate a downward-facing ultra-wide-angle 4K camera 14, complemented by a high-intensity LED flash 15, to enable clear and detailed visual monitoring under varied lighting conditions.

Sensing Technology: For precise fluid level detection, the Vision Float (system 100) is equipped with an ultrasonic depth perception sensor 12 and/or a LiDAR sensor, thereby ensuring accurate data acquisition.

Connectivity Module (communication module 16): An embedded LTE modem facilitates seamless data transmission for real-time monitoring and alerting functionalities. Additionally, the system is provisioned with Bluetooth and Wi-Fi capabilities for enhanced local connectivity options.

Power Supply 17: The Vision Float (system 100) may include an integrated lithium-ion battery, complemented by a 120-volt NEMA plug affixed via a cord to the top, to ensure a continuous power supply. An in-built AC/DC charger is provided to maintain the battery in a charged state.

Auxiliary Sensors: Equipped with a temperature sensor 12 and an accelerometer 13, the Vision Float is capable of monitoring environmental conditions and the system/device's orientation, respectively.

In a preferred embodiment, the present invention includes a rectangular housing 10 with multiple sensors 12 attached to its outer surface, accelerometers 13 embedded within the rectangular housing 10, cameras 14 and flashlights 15 mounted on the exterior, and a communication module 16 embedded inside the rectangular housing 10. The rectangular housing 10 also contains a power supply 17 that is communicatively connected to the sensors 12, accelerometers 13, cameras 14, flashlights 15, and communication module 16.

In certain embodiments, the present invention may comprise one or more legs 30 and one or more hangers 20 (which can be a cord) designed to suspend the invention within a fluid-filled tank 40.

The operational essence of the Vision Float is predicated on its suspension via a cord (hanger) 20 above the liquid within any tank 40 or structure requiring monitoring.

Upon installation and connection to a power source, the system 100 autonomously registers itself over cellular networks to our servers, thereby initiating its monitoring capabilities. Users interface with the Vision Float through a dedicated application or web browser, enabling them to set desired alert thresholds and access live feeds and data analytics.

Upon the fluid level reaching a pre-determined threshold 60 relative to the system/device 100, the Vision Float's sensing technology activates the camera 13 and LED flash 14, capturing a photograph of the interior conditions of the tank 40, which is subsequently transmitted to the user alongside an alert notification. This functionality affords users the capability to visually verify the fluid 50 level or the fluid level remotely from a smartphone or PC. In instances where the Vision Float becomes submerged, the internal accelerometer 14 detects this alteration in orientation, triggering an alert to the user. The system/device 100 is ingeniously designed to float and reorient itself to face upwards, ensuring its operational continuity and monitoring efficacy.

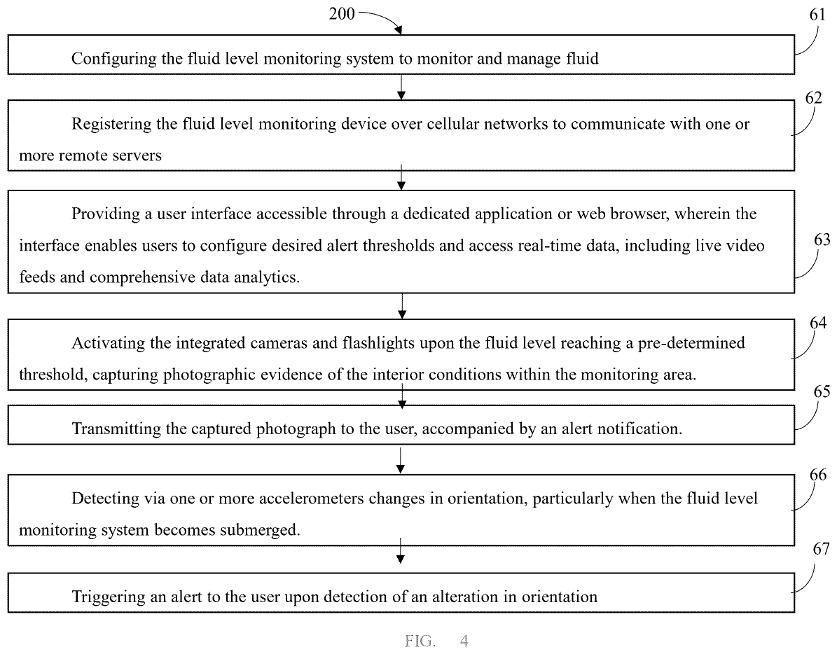

As an example, in one embodiment, as shown in FIG. 4, the present invention provides a method 200 that includes the following steps:

Configuring the fluid level monitoring system to monitor and manage fluid levels within a designated environment (at 61).

Registering the fluid level monitoring device over cellular networks to communicate with one or more remote servers (at 62).

Providing a user interface accessible through a dedicated application or web browser, wherein the interface enables users to configure desired alert thresholds and access real-time data, including live video feeds and comprehensive data analytics (at 63).

Activating the integrated cameras and flashlights upon the fluid level reaching a pre-determined threshold, capturing photographic evidence of the interior conditions within the monitoring area (at 64).

Transmitting the captured photograph to the user, accompanied by an alert notification, thereby informing the user of the current status (at 65).

Detecting via one or more accelerometers changes in orientation, particularly when the fluid level monitoring system becomes submerged (at 66).

Triggering an alert to the user upon detection of an alteration in orientation, ensuring timely notification of potential issues (at 67).

This method 200 provides a robust solution for fluid management, offering real-time monitoring capabilities and responsive alert mechanisms to effectively address fluid level changes.

The present invention presents a novel, set-and-forget solution to liquid tank level monitoring, characterized by its affordability and user-friendly interface accessible via browser or mobile application. Its comprehensive design and operational features render it an indispensable asset for enhancing operational efficiency and safety within the wastewater industry and beyond.

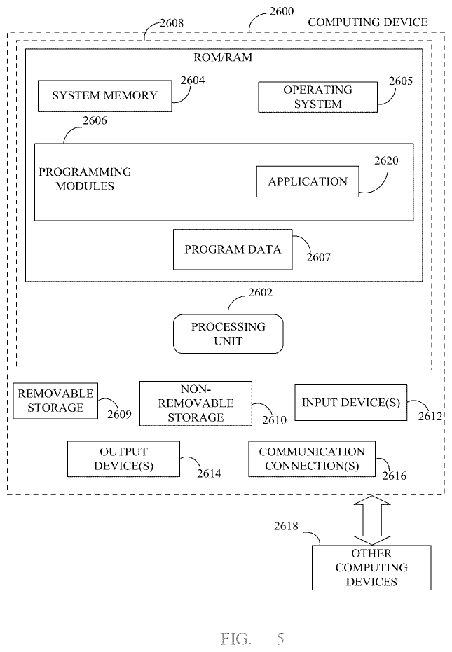

With reference to FIG. 5, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile (e.g. random-access memory (RAM)), non-volatile (e.g. read-only memory (ROM)), flash memory, or any combination. System memory 2604 may include operating system 2605, one or more programming modules 2606, and may include a program data 2607. Operating system 2605, for example, may be suitable for controlling computing device 2600's operation. In one embodiment, programming modules 2606 may include image-processing module, machine learning module, etc. Furthermore, embodiments of the disclosure may be practiced in conjunction with a graphics library, other operating systems, or any other application program and is not limited to any particular application or system. This basic configuration is illustrated in FIG. 5 by those components within a dashed line 2608.

Computing device 2600 may have additional features or functionality. For example, computing device 2600 may also include additional data storage devices (removable and/or non-removable) such as, for example, magnetic disks, optical disks, or tape. Such additional storage is illustrated in FIG. 5 by a removable storage 2609 and a non-removable storage 2610. Computer storage media may include volatile and non-volatile, removable and non-removable media implemented in any method or technology for storage of information, such as computer-readable instructions, data structures, program modules, or other data. System memory 2604, removable storage 2609, and non-removable storage 2610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2600. Any such computer storage media may be part of device 2600. Computing device 2600 may also have input device(s) 2612 such as a keyboard, a mouse, a pen, a sound input device, a touch input device, a location sensor, a camera, a biometric sensor, etc. Output device(s) 2614 such as a display, speakers, a printer, etc. may also be included. The aforementioned devices are examples and others may be used.

Computing device 2600 may also contain a communication connection 2616 that may allow device 2600 to communicate with other computing devices 2618, such as over a network in a distributed computing environment, for example, an intranet or the Internet. Communication connection 2616 is one example of communication media. Communication media may typically be embodied by computer readable instructions, data structures, program modules, or other data in a modulated data signal, such as a carrier wave or other transport mechanism, and includes any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2604, including operating system 2605. While executing on processing unit 2602, programming modules 2606 may perform processes including, for example, one or more stages of methods, algorithms, systems, applications, servers, databases as described above. The aforementioned process is an example, and processing unit 2602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

1. fluid level monitoring system comprising: a housing; one or more sensors attached to the exterior of the housing; one or more accelerometers embedded within the housing; one or more cameras mounted on the exterior of the housing; one or more flashlights mounted on the exterior of the housing; a communication module embedded inside the housing; and a power supply communicatively connected to the one or more sensors, accelerometers, cameras, flashlights, and communication module.

2. he fluid level monitoring system as claimed in claim 1, wherein the housing includes a rectangular shape.

3. he fluid level monitoring system as claimed in claim 2, wherein the housing includes an impact-resistant plastic shell.

4. he fluid level monitoring system as claimed in claim 2, wherein the one or more sensors include LiDAR sensors.

5. he fluid level monitoring system as claimed in claim 3, wherein the one or more sensors include temperature sensors.

6. he fluid level monitoring system as claimed in claim 1, wherein the housing is configured to be attached within a fluid-filled tank.

7. fluid level monitoring system comprising: a housing having one or more legs and a hanger; one or more sensors attached to the exterior of the housing; one or more accelerometers embedded within the housing; one or more cameras mounted on the exterior of the housing; one or more flashlights mounted on the exterior of the housing; a communication module embedded inside the housing; and a power supply communicatively connected to the one or more sensors, accelerometers, cameras, flashlights, and communication module.

8. he device as claimed in claim 7, wherein the housing includes a rectangular shape.

9. he device as claimed in claim 8, wherein the housing includes an impact-resistant plastic shell.

10. he device as claimed in claim 8, wherein the one or more sensors include LiDAR sensors.

11. he device as claimed in claim 7, wherein the one or more sensors include temperature sensors.

12. he fluid level monitoring system as claimed in claim 7, wherein the housing is configured to be attached within a fluid-filled tank.

13. A method for monitoring and managing fluid levels by a fluid level monitoring system, the method comprising:
registering the fluid level monitoring system over cellular networks to one or more servers;
providing a user interface through a dedicated application or web browser, wherein the user interface enables users to set desired alert thresholds and access live feeds and data analytics;
activating the one or more cameras and flashlights upon a fluid level reaching a pre-determined threshold, capturing a photograph of the interior conditions of a monitoring area, and transmitting the photograph to a user alongside an alert notification; and
detecting an alteration in orientation of the fluid level monitoring system using the one or more accelerometers when the fluid level monitoring system becomes submerged, and triggering an alert to the user.

14. The method as claimed in claim 9, wherein:
the fluid level monitoring system includes
a housing;
one or more sensors attached to the exterior of the housing;
one or more accelerometers embedded within the housing;
one or more cameras mounted on the exterior of the housing;
one or more flashlights mounted on the exterior of the housing;
a communication module embedded inside the housing; and
a power supply communicatively connected to the one or more sensors,
accelerometers, cameras, flashlights, and communication module.

15. The method as claimed in claim 14, wherein the housing includes a rectangular shape.

16. The method as claimed in claim 14, wherein the housing includes an impact-resistant plastic shell.

17. The method as claimed in claim 15, wherein the one or more sensors include LiDAR sensors.

18. The method as claimed in claim 15, wherein the one or more sensors include temperature sensors.

19. The method as claimed in claim 15, wherein the housing is configured to be attached within a fluid-filled tank.

20. The method as claimed in claim 14, wherein the fluid level monitoring system is installed in a tank filled with fluid.
